(19) United States
(12) Patent Application Publication
(10) Pub. No.: US 2016/0304327 A1
(43) Pub. Date: Oct. 20, 2016

(54) Pivot Power Pack and Balancing Frame (A Mini Lifter Attachment for an Electric Scooter)

(71) Applicant: Emanuel J. Micallef, Mississauga (CA)

(72) Inventor: Emanuel J. Micallef, Mississauga (CA)

(21) Appl. No.: 14/691,223

(22) Filed: Apr. 20, 2015

(51) Int. Cl. B66F 9/075; B66F 9/22; B66F 9/12

(52) U.S. Cl. CPC B66F 9/07559; B66F 9/07531; B66F 9/12; B66F 9/22; B66F 9/07504

(57) ABSTRACT

This invention provides an attachment to an electric scooter which is designed to allow persons with disabilities or injury to lift and carry pallets of up to 230 lbs. This invention uses a 12 VDC actuator to allow the front portion of the attachment to tilt over a pivot system. Other 12 VDC actuators are used to provide the ability to raise and lower the forks. All actuators can be replaced with equivalent hydraulic technologies. This invention includes a unique safety feature which allows the forks to be raised to 95 degrees in order to provide increased maneuverability and safety while there is no load. When the Balancing Stability Frame is attached to the Pivot Power Pack, the weight of the load that is being lifted is supported by the Pivot Power Pack wheels. When the Pivot Power Pack and Balancing Stability Frame are connected to a mobility scooter, the weight of the operator and the counterbalance attached to the Balancing Stability Frame is equally distributed across all the wheels. This design minimizes the amount of weight supported by the scooter, which helps to preserve the durability of the scooter.

### TECHNICAL FIELD

The application relates generally to lifting and carrying machines, specifically machines that can be used by people with disabilities.

### BACKGROUND OF INVENTION

Traditional lift trucks such as: CA 2571225, TYGARD are used for lifting material and stacking them in shelves with forks that are straight out. These traditional lift trucks are not allowed in most public areas due to safety concerns. Smaller lift trucks are equipped with a base that the operator stands on to drive the machine. Some self-propelled models are also available, but these require the operator to walk alongside the machine. Other hydraulic lifters or hand trucks must be pushed or pulled by an operator. None of these existing lifting and carrying machines can be used by people with physical disabilities.

### SUMMARY OF INVENTION

The Pivot Power Pack is different from the existing technology that is currently available because it allows handicapped and injured persons to move skids, pallets and containers of up to 230 lbs. The Pivot Power Pack has been designed with a narrow wheel base which allows a high degree of maneuverability that is beyond the capabilities of the existing technologies outlined above. The Pivot Power Pack has been designed as an attachment for the reliable and widely used electric scooters that are typically used by people with physical disabilities such as the CA 2501090, RICHEY model.

The Pivot Power Pack is designed to distribute the maximum weight it carries, up to of 230 lbs., onto its wheels. The Pivot Power Pack's design also includes a Balancing Stability Frame. When the Balancing Stability Frame is attached, all the weight of the operator and the counter balance is distributed over the Pivot Power Pack's 6 wheels for a 3-wheel scooter or 7 wheels for a 4-wheel scooter. This design minimizes the weight that is supported by the scooter itself.

The Pivot Power Pack (P.P.P.) uses swivel steel wheels with nylon cushions to maneuver. The Pivot Power Pack's Balancing Stability Frame distributes the weight of the load over the centre point of the swivel steel wheels. The main shaft that the P.P.P. pivots on has four bearings that allow it to operate with ease and maximizes its maneuverability.

The track that guides the P.P.P's lifters is oriented to the structure with parallel double pipes to ensure the rigidity and stability of the load. The main actuator on the prototype is 18 inches, but can be operated with different models of actuators that go up to 24 inches in height. Two other actuators tilt back to ensure the stability of the load. The main stabilizers are attached to the main guide. There is a second rail guide that tilts at the same time as the pivot lifter. The second guide has extended rail guides which allow the actuator to reach a maximum height of 24 inches. A welded back plate attaches the rugged steel frame of the Pivot Power Pack to its Balancing Stability Frame via three flanges using a total of six bolts. These flanges are heavy-duty (as shown in the accompanying drawing) to ensure the stability of the Balancing Stability Frame.

Unlike conventional lift trucks, the Pivot Power Pack has another actuator which allows the forks to be folded up to 95 degree angle when no load is being carried. Not only does this design ensure higher safety it also allows for improved maneuverability in tight spots. The Pivot Power Pack's lifters are guided by two rollers, one on the base of the P.P.P and one on the lift rail guide for increased load stability. The Pivot Power Pack's design allows for maximum stability when a maximum load is being carried. The Pivot Power Pack has all required accessories for operation. This includes: its own independent source of power; adjustable rear-view mirrors; and, a control panel that can be adjusted to suit the operator. Each of these functions is controlled by separate switches.

The Pivot Power Pack's Balancing Stability Frame (B.S.F.) is attached to the base of the scooter by two ⅝″ bolts and two metal plates, one over and one under, the base of the scooter. The Balancing Stability Frame's rear stability wheels can be adjusted to accommodate heavier operators and heavier loads. These adjustable stability wheels weight are designed to transfer off of the scooter's base and onto the adjustable rear wheel and the Pivot Power Pack's main wheels. When lifting lighter weights (120 lbs or less), the upper portion of the Balancing Stability Frame is not required. The rear stability wheels are attached to the B.S.F. and to the main stem of the scooter's chair underneath its locking mechanism. A counter balance is attached to the front of the rear wheel. The design of the Balancing Stability Frame allows for easy access to the scooter and also incorporates a hand strap for easy mounting and dismounting of the scooter. The design of the scooter itself—including its anti-tip wheels and all other components—and all other parts of the scooter are not changed or modified in any way.

### BRIEF DESCRIPTION OF THE DRAWINGS

FIG. 1 is a detailed cross-sectional view of the Pivot Power Pack when detached from the Balancing Stability Frame.

FIG. 2 is a cross-sectional view of the Balancing Stability Frame and adjustable rear wheel with counter balance attachment.

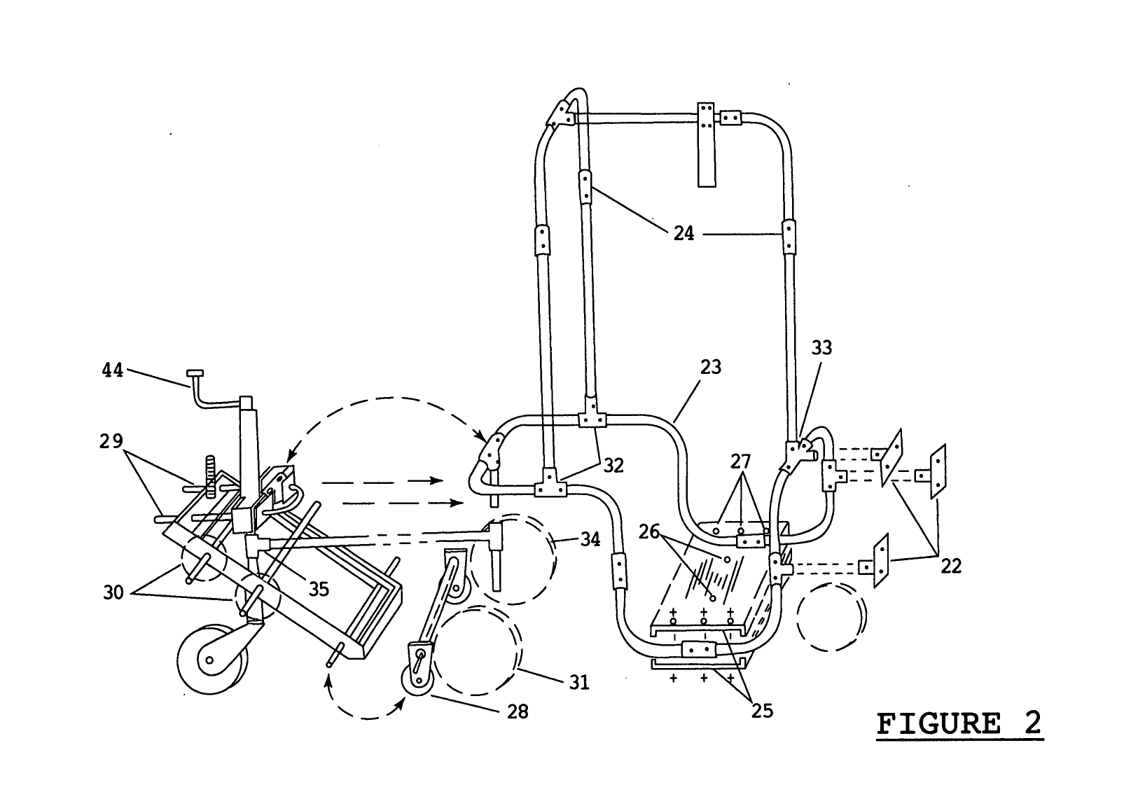

FIG. 3 is a wiring diagram for the Pivot Power Pack control panel.

### DETAILED DESCRIPTION OF INVENTION

This invention has a rugged steel base (18) with supporting brackets for the back plate (21). The Pivot Power Pack swivel steel wheels (5) are attached with four bolts to the base. They are attached to the mid-point of the base on either side. The swivel steel wheels (5) may have a diameter of about 20 cm, may be rated to support 300 lbs and optionally may be made from cast iron. The Pivot Power Pack wheels (5) consist of steel wheels with a nylon cushion. These nylon cushions reduce friction with the floor when the machine is in motion. This enhances the steering and maneuverability of the Pivot Power Pack. Optionally, the Pivot Power Pack may have a height of about 152 cm above the ground and a width of about 64 cm.

The front of the base has rollers (17) which guides and stabilizes the load as it is being lifted. The support guides (10) has a bracket which has a second roller attached to it, which is located 10″ above the main roller (17).

The Pivot Power Pack is designed with rugged bearings (12), four in quantity, which are attached to the base, two on either side of the main lift (1). The main shaft goes through the bearings (12) until halfway on the plate, where a swivel pin is inserted through the actuator (1) with a sleeve that goes through the length of the shaft.

This invention has a unique feature where the forks (7) fold back to 95 degrees for safety purposes when driving without a load. Optionally, the forks (7) may have a length of about 72 cm measured from the pivot location. This feature also enhances the maneuverability while driving in tight spots. The main lifters (45) are coupled at a 90 degree angle that connects to the forks housing which contains a connecting stability bar that goes to the opposite side of the lifter where a similar housing connects. The forks (7) are connected to the housing with heavy duty pins (6) which allow for maximum load. The forks (7) pivot on the heavy duty pins (6) when they fold to 95 degrees. The forks (7) are attached to a steel cable at their ends, with a steel spring that is attached to both the heavy duty pins (6) and the steel cable. This keeps the wire in the channel that is inside the forks (7). This applies for both forks. Each end of the forks (7) has a tapered steel cover that allows pallets to slide over the forks with ease and to protect the steel cable and attached spring. The main lifters (45) have a mounting bracket (16) attached to the bottom of both sides which is also attached to the housing. The forks safety lift actuator (3) is mounted in the centre of the mounting bracket (16). The forks safety lift actuator (3) may be configured to operate on 12 VDC, with a 240 mm stroke, a 135 lbs max law and a speed of about 0.31 m/sec. Attached to the mounting bracket (16) are two lifting guides (8) which have a surrounding sleeve for stability. The top of the lifting guides (8) are attached to the actuator lifting cable bracket. The steel cable used to lift the forks (7) passes through a guide attached to the mounting bracket (16). The steel cable is attached to the actuator lifting cable bracket, which is as wide as the forks (7).

The main lifters (45) are comprised of two doubled sleeves that are the full height of the lifter. The main lifters (45) are attached to the support guides (10) with an additional bracket that attaches to a sleeve that acts as a guide for the main lifters (45). The main lifters (45) are attached with an angled bracket that goes between the sliding support guides (10) and the main lifter actuator bracket (13), attached to the main lift (1). The main actuator (1) is attached to a swivel heavy duty pin, with a spring loaded bracket which is attached to the bracket that is attached to the main guides. The top of the main lifter actuator bracket (13) is attached to a sleeve that goes into the sliding support guide (10). Optionally, the main lifter actuator bracket (13) can be positioned at a height of about 104 cm above the base (18). This sliding support guide (10) guides the main lift (1).

The Pivot Power Pack has its own independent power source (4), which is mounted on an isolator from the steel base. This is attached with a nylon strap to the base. Thus the battery is easily accessible and all four actuators (1, 2a, 2b, 3) are powered by this single power source (4). All controls and electrical wires are connected to this battery (4). A 30 amp fuse is provided from the battery (4). The battery (4) may be selected to have 35 Amp hours (20 Hrs) and 52 Rev. Cap minutes.

The main lift (1) is attached to the main support bracket (11), which is attached to the support guides (10) on either side. Another bracket is attached to the main support bracket (11) for the rear view mirrors (15). The main lift (1) can be configured to operate on 12 VDC and have a 20:1 gear ratio, a 1500 N max load, a 457 mm stroke, a 26% stroke and may use an acme drive.

Two support brackets attach to the end of the support guides (10) and two brackets at the bottom of the support guides (10) hold a plexiglass safety shield (14).

The load stabilizing actuators (2a, 2b) are attached to a bracket (20) that is attached to the back plate (21) horizontally. This bracket is supported by another bracket to the back plate (21). The load stabilizing actuator (2a, 2b) is latched to a bracket with a plate on either side with a swivel pin on the actuator which attaches to the support guide (10). The pin is enclosed around the support guide (10) which sits on an adjustable stopper, one on top (9), one on the bottom. Optionally, the support guide 10 may have a height of about 124 cm. This will allow the amount of tilt forward or backward as desired. This is a heavy duty pin to prevent the pivot from tilting farther than desired. The load stabilizing actuator (2a, 2b) may be configured to be operable on 12 VDC, have a 120 mm stroke, a 135 lbs max load and a speed of about 0.31 m/sec.

There are two guides that are attached to the back plate (21) which go through the support guides (10). There is an adjustable plate (19) on either side of the guide, one adjusted for the distance that the Pivot Power Pack can tilt backwards, and the other for the distance the Pivot Power Pack can tilt forwards.

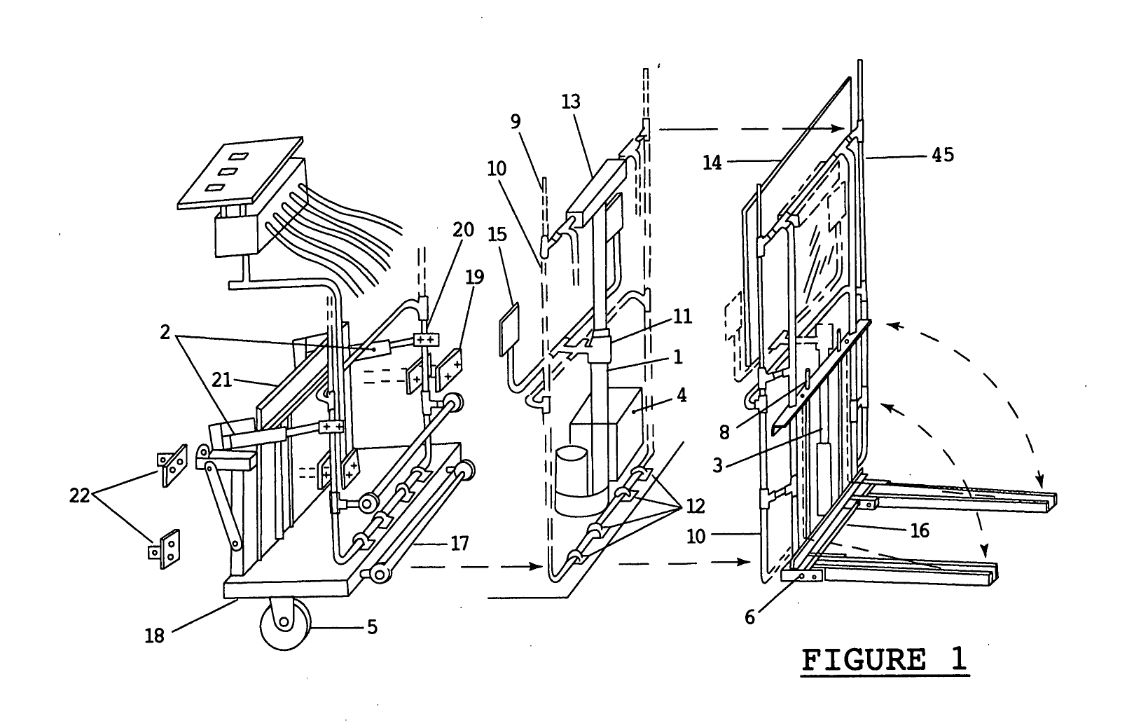

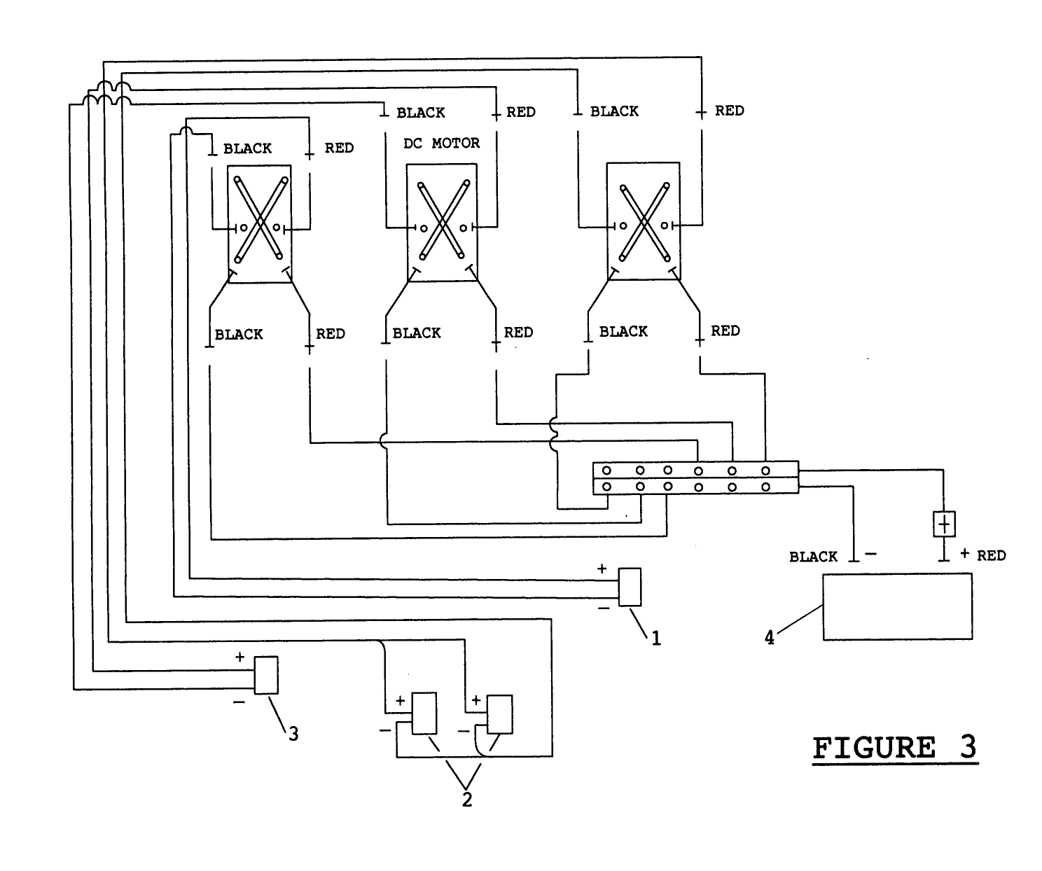

A bracket is attached to the back plate (21) which is attached to the swivel bracket for the electrical control panel (see FIG. 1A). This control panel comprises of three switches, one for the main lift (1), one for the load stabilizing actuators (2a, 2b), and one for the forks safety lift actuator (3). This control panel is totally enclosed and a plexiglass cover that protrudes above the electrical box is used to protect the electrical wiring. This cover has complete operating instructions for the Pivot Power Pack. All wiring for each actuator leads separately from the battery to the control panel. The control panel swivels and tilts to operator's specific needs. See FIG. 3A for wiring diagram of the control panel.

The Balancing Stability Frame is constructed of 1.5″ steel tubing with heavy duty steel galvanized connectors. All connectors are rated at 7550 lbs.

Three heavy duty flanges (22) (rated at 7550 lbs) with two bolts each, attach the Pivot Power Pack back plate (21) to the Balancing Stability Frame. These are attached with ⅝″ bolts with wing nuts on the Balancing Stability Frame side for easy detachment.

The upper portion of the Balancing Stability Frame attaches to the main upper flange (33) of the Balancing Stability Frame. This vertical portion of the frame attaches to a horizontal upper frame, where a hand strap is mounted, for easy mounting and dismounting of the scooter. The horizontal upper portion of the Balancing Stability Frame is connected to a T-Connector that is connected to a bracket that is the width of the frame. This bracket is connected with sleeves (24) to vertical tubing which is connected to another T-Connector (32) on either side. This T-Connector (32) is connected to an elbow (23) which is connected to horizontal tubing that goes through the bottom of the scooter and then to the flanges (23) in front.

At the bottom of the vertical tubing at the T-Connector (32), two elbows (23), one on either side, are connected to another T-Connector at the back. Vertical tubing connects this T-Connector to the swivel connector (35) which is attached to a bracket that connects the swivel connector (35) to the seat stem (34) below the seat attachment.

The adjustable rear wheel is connected to the swivel connector (35) and the counter balance bracket. The counter weight bracket makes a 45 degree angle with the rear wheel. This connects to the outside of the anti-tip wheels (28).

The counter weight bracket houses one 25 lbs weight (30) and two 10 lbs weights on either side. The rear adjustable wheel has an adjustment control (29) which controls the height of the counter balance bracket. The connecting bracket between the swivel connector (35) and the seat stem (34) is attached to the counter balance bracket.

The adjustable rear wheel is a ten inch swivel rubber tire. The adjustable rear wheel also has a manual adjustable handle (44) to lower or raise the wheel to compensate for heavier operators and to balance the overall weight of the counter weight attachment with the operator. This also transfers this weight proportionally to the Pivot Power Pack's steel wheels. This will ensure even weight distribution.

The base of the scooter requires two ⅝″ holes where no electrical wires or structural support exists. Two heavy duty steel plates (25), one on top of the scooter base, one below, have full width gaskets (cushions). The top steel plate has a non-skid rubber attachment which covers the two ⅝″ bolts (26) that go through the two metal plates and the scooter. Both sides of the plates contain ⅜″ bolts (27) that clamps the Balancing Stability Frame to the scooter. This creates a positive attachment to the base of the scooter. The non-skid rubber attachment also covers the ⅜″ bolts (27). This gives a ground clearance of 9 cm.

The counter weight and rear wheel bracket is a heavy duty unit, which allows for heavier counter weights to be used. This also contains a provision for additional counter weights if required.

The Balancing Stability Frame is designed to give easy access and stability to mount and dismount the scooter. The radius of the design and the upper horizontal bar creates a stable attachment to the Pivot Power Pack. The adjustable rear wheel is designed to ensure that the front of the scooter maintains steering ability at all times with the maximum load on the Pivot Power Pack.

The Pivot Power Pack, with its Balancing Stability Frame, is designed to be used only indoors, on level surfaces when attached to a regular mobility scooter. Its compact design can lift a maximum load of 230 lbs. This is achieved by using similar principles to those utilized by hydraulic pump trucks which enable employees to easily transport heavy skids weighing 300 lbs. or more across flat surfaces with minimal effort.

The Pivot Power Pack has been designed specifically to assist people with physical disabilities to access employment opportunities in the: manufacturing, distribution, retail, commercial, hospitality health care and retail sectors—anywhere where the lifting and transporting of goods is required. With its compact design and high degree of maneuverability, the Pivot Power Pack is ideally suited for environments where load weights are smaller (up to 230 lbs.) and where larger, traditional lift trucks cannot be utilized.

1. A combination of a balancing stability frame and a pivot power pack for connecting to an electric scooter, wherein the balancing stability frame is attachable to the electric scooter without changing an original state of the electric scooter with the exception of two holes in a base of the electric scooter for attaching the balancing stability frame to the scooter, and wherein the pivot power pack is attachable to the balancing stability frame.

2) The combination of claim 1, wherein the Balancing Stability Frame is designed to have access to the scooter without changing dimensional access provided for the scooter.

3) The combination of claim 1, wherein the Balancing Stability Frame attaches to the seat stem under the scooter's chair with a swivel coupling.

4) The combination of claim 1, wherein the Balancing Stability frame has an adjustable rear wheel that swivels and thus enhances the stability and the balance of the frame in claim 1.

5) The combination of claim 1, wherein the swivel rear wheel has an attached bracket that carries the counter balance attachment that stabilizes the steering ability of the scooter, this counter balance attachment is mounted on a stem with a removable pin which allows the amount of weight to be easily changed.

6) The combination of claim 4, wherein the rear wheel has a manual adjustment for heavy operators and for heavier loads.

7) The combination of claim 1, wherein the Balancing Stability Frame has a hand strap for easy mounting and dismounting at the upper horizontal bar.

8) The combination of claim 1, wherein the Balancing Stability Frame has three flanges that attach with wing nuts for easy detachment from the Pivot Power Pack.

9) The combination of claim 4, wherein the Balancing Stability Frame has an easy detachment of the rear wheel from the seat stem that does not require removal of the seat.

10. A balancing stability frame for attaching to a scooter having a base, the balancing stability frame comprising:
a top steel plate configured to cover a top surface of the base;
a bottom steel plate configured to cover an opposed bottom surface of the base;
two attaching bolts securing the top steel plate to the bottom steel plate and passing though the base;
a rubberized gasket disposed between the bottom steel plate and the bottom surface of the base; and
a non-slip rubber cover disposed on the top steel plate and covering the attaching bolts.

11) The balancing stability frame of claim 10, wherein the top steel plate and the bottom steel plate have three bolts on either side that act like a clamp to the base of the scooter.

12) The combination of claim 1 is connectable to 3 wheel scooters, 4 wheel scooters, and scooters of any width.

13) The combination of claim 1, wherein an upper portions of the Balancing Stability Frame is removable when lifting lighter loads on a continuous basis.

14) The combination of claim 1 wherein the Pivot Power Pack has a rugged steel base and a back plate, which are where two swivel steel wheels with nylon cushions are attached.

15. A pivot power pack for connecting to a scooter, the pivot power pack comprising;
a base having a width;
a main shaft pivotally coupled to the base by four bearings;
main sliding guides connected to and pivotable with the main shaft;
vertical sleeved lifters slidingly coupled to the main sliding guides and slideable in unison with each other to lift a load; and
two guide rollers coupled to the base and extending the full width of the base to guide the movement of the vertical sleeved lifters thereby enhancing the stability of the load on the vertical sleeved lifters.

16) The pivot power pack of claim 15, wherein the main lifters include double tubular sleeves for rigidity, the main guide has another attachment mounted parallel to the double sleeved tubular sliding guides to stabilize the sliding lifters in position.

17) The pivot power pack of claim 15, wherein the base of the sliding lifters has a bracket that has an actuator mounted to it for the tilting of the forks to 95 degrees for safely and maneuverability without a load.

18) The pivot power pack of claim 17, wherein the bottom of the lifters attach to a housing where the forks are attached with a heavy duty pin, and fork leveling adjustment.

19) The Pivot Power pack of claim 18, wherein the forks are equipped with a spring that attaches to the heavy duty pivoting pin, as well as to the front of the forks with a steel cable, the steel cable sits in groove provided and a cover plate is used to protect the cable and spring when lifting pallets.

20) The Pivot Power Pack of claim 19, wherein the steel cable attaches to a guide in the mounting bracket and it is attached to the housing for the Pivoting Pin which attaches to the bracket of the forks safely lift actuator.

21) The Pivot Power Pack of claim 20, wherein the safety actuator mechanism has two lifter guides with a sleeve for rigidity.

22) The Pivot Power Pack of claim 15, wherein the Pivot Power Pack is equipped with an actuator on either side that will stabilize the load by pulling forward or backward, these are attached to the main guides of the Pivot Power Pack

23) The Pivot Power Pack of claim 22, wherein the Pivot Power pack has a safety adjustment that controls how far the Pivot Power Pack tilts forward or backwards,

24) The Pivot Power Pack of claim 15, wherein the Pivot Power Pack main guides have an attached sliding sleeve that is the full length of the sliding lifters but compensates by 30 cm for higher lifters, up to 60 cm.

25) The Pivot Power Pack of claim 15, wherein the sliding guide is attached to the main guide that has a plexiglass shield to protect the operator.

26) The Pivot Power Pack of claim 15, wherein the Pivot Power Pack has a recessed bracket that goes from one end to the other of the main lifter guides, which attach to the top of the main actuator by a coupling for stability of the actuator.

27) The pivot Power Pack of claim 26, wherein the main actuator has a pin that goes through the full length of the base with a double sleeve for rigidity and to promote less friction when carrying a load.

28) The Pivot Power Pack of claim 27, wherein the top of the main actuator has a spring loaded pin which attaches to a bracket with six bolts and another bracket that is between the main guide and the main lifter guides, both brackets are attached to each other, to enhance the pivoting ability at the top of the actuator to maintain steady loads, wherein the spring loaded pin prevents the main lifter from shifting.

29) The Pivot Power Pack of claim 28, wherein the main lifter guide has another bracket which supports two rear view mirrors.

30) The Pivot Power Pack of claim 15, wherein a back plate has a bracket that houses an adjustable and swivel ability of a control panel, to be adjusted to different sizes of operators, and the control panel also pivots to suit the needs of the operator.

31) The Pivot Power Pack of claim 30, wherein the control panel houses all wiring that is required for the Pivot Power Pack, has three switches for a Pivot Power Pack controls including one for the main actuator up and down, one for the stabilizing actuators forward or backward and one switch for lifting the forks to 95 degrees when there is no load for safety and maneuverability.

32) The Pivot Power Pack of claim 15, wherein the Pivot Power Pack back plate has welded bolts that will attach to the Balancing Stability Frame in claim 10 to allow easy detachment.

33) The Pivot Power Pack of claim 32, when detached from the Balancing Stability Frame, is free-standing when the forks are tilted to 95 degrees and the housing is resting on the ground, the Pivot Power Pack does not require an additional support to stand and is ready to be attached to the Balancing Stability frame at any time with six wing nuts.

34) The Pivot Power Pack of claim 33 further comprising an independent power source including a battery that is strapped to the back plate with a nylon strap and is totally enclosed.
